(19) United States
(12) Patent Application Publication
(10) Pub. No.: US 2025/0189219 A1
(43) Pub. Date: Jun. 12, 2025

(54) METHOD FOR PRESSURIZING A LIQUID EXITING A PHASE SEPARATOR

(71) Applicant: Air Liquide Large Industries U.S. LP, Houston, TX (US)

(72) Inventor: Gary D. Miller, Houston, TX (US)

(21) Appl. No.: 18/530,483

(22) Filed: Dec. 6, 2023

(51) Int. Cl. F25J 3/06

(52) U.S. Cl. CPC F25J 3/0695; F25J 3/0655; F25J 2205/02; F25J 2235/04

(57) ABSTRACT

A method for pressurizing a liquid exiting a phase separator includes opening an inlet control valve, thereby providing a two-phase fluid stream to a phase separator and producing a vapor stream and a liquid stream. Wherein a first liquid control valve prevents the liquid stream from leaving the phase separator. Then closing the inlet control valve and opening the first liquid control valve, thereby withdrawing the liquid stream from the phase separator and introducing the liquid stream into a lock hopper. Wherein, a second liquid control valve prevents the liquid stream from leaving the lock hopper. Then closing the first liquid control valve and then opening a pressurized vapor control valve, thereby providing a pressurized vapor stream to the lock hopper, thereby pressurizing the lock hopper. Then closing the pressurized vapor control valve, and opening the second liquid control valve, thereby withdrawing a pressurized liquid stream from the lock hopper.

### BACKGROUND

It is often necessary for a fluid to experience a phase separation, at which point the liquid phase is essentially at the vaporization point. This is especially true for cryogenic liquids, such as cryogenic hydrogen. Such a fragile liquid is difficult to pressurize in many pumps (such as centrifugal pumps) as they will tend to vaporize at the impeller suction and can produce destructive cavitation. Therefore, there is a need in the industry for a method of pressurizing a liquid stream exiting a phase separator.

### SUMMARY

A method is presented for pressurizing a liquid exiting a phase separator, including providing a two-phase fluid stream to a phase separator, thereby producing a vapor stream and a liquid stream, withdrawing the liquid stream from the phase separator and introducing the liquid stream into a lock hopper, providing a pressurized vapor stream to the lock hopper, thereby pressurizing the lock hopper, and withdrawing a pressurized liquid stream from the lock hopper.

A method for pressurizing a liquid exiting a phase separator is also provided. This method includes opening an inlet control valve, thereby providing a two-phase fluid stream to a phase separator and producing a vapor stream and a liquid stream, wherein a first liquid control valve prevents the liquid stream from leaving the phase separator. Next the method includes closing the inlet control valve and opening the first liquid control valve, thereby withdrawing the liquid stream from the phase separator and introducing the liquid stream into a lock hopper, wherein, the lock hopper has a lock hopper pressure and a second liquid control valve prevents the liquid stream from leaving the lock hopper. Then closing the first liquid control valve and then opening a pressurized vapor control valve. The control valve provides a pressurized vapor stream to the lock hopper, thereby pressurizing the lock hopper. Then closing the pressurized vapor control valve, and opening the second liquid control valve, withdraws a pressurized liquid stream from the lock hopper.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of the basic layout of the system to pressurize a liquid, in accordance with one embodiment of the present invention.

FIG. 2 is a schematic representation of the “first transition” phase of the system to pressurize a liquid, in accordance with one embodiment of the present invention.

FIG. 3 is a schematic representation of the “liquid filling” phase of the system to pressurize a liquid, in accordance with one embodiment of the present invention.

FIG. 4 is a schematic representation of the “second transition” phase of the system to pressurize a liquid, in accordance with one embodiment of the present invention.

FIG. 5 is a schematic representation of the “liquid pressurizing” phase of the system to pressurize a liquid, in accordance with one embodiment of the present invention.

FIG. 6 is a schematic representation of the “liquid at pressure” phase of the system to pressurize a liquid, in accordance with one embodiment of the present invention.

FIG. 7 is a schematic representation of the “liquid draining” phase of the system to pressurize a liquid, in accordance with one embodiment of the present invention.

FIG. 8 is a schematic representation of the “third transition” phase of the system to pressurize a liquid, in accordance with one embodiment of the present invention.

FIG. 9 is a schematic representation of the “system venting” phase of the system to pressurize a liquid, in accordance with one embodiment of the present invention.

### ELEMENT NUMBERS

101=stream to be separated
102=phase separator
103=separated liquid stream
104=separated vapor stream
105=first liquid control valve
106=lock hopper
107=second liquid control valve
108=liquid stream to storage
109=gaseous stream
110=vent control valve
111=gaseous vent stream
112=pressurized gas control valve
113 pressurized gas phase stream
114=first pressure sensor
115=second pressure sensor
116=first level transmitter
117=second level transmitter
118=inlet stream control valve
119=liquid

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

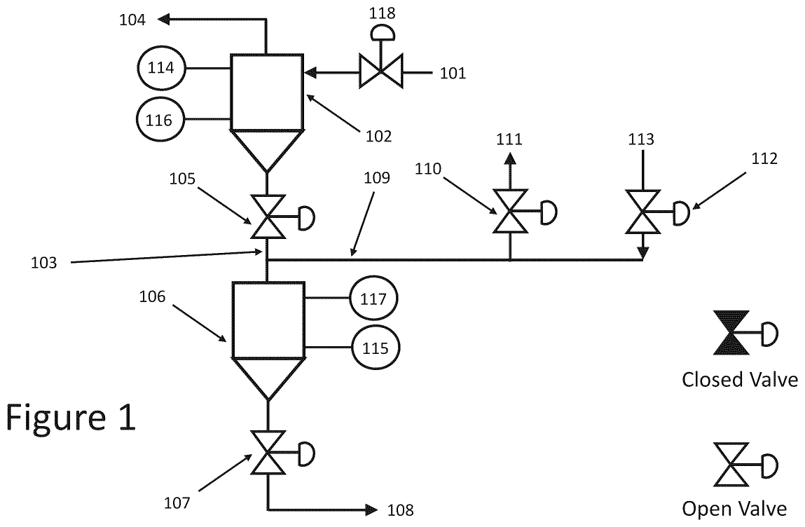

Turning to FIG. 1, the basic layout of a system to pressurize a liquid stream according to one embodiment of the present invention is provided. After passing through inlet stream control valve 118, two-phase, or liquid phase, stream 101 is introduced into phase separator 102, thereby producing liquid stream 103 and vapor stream 104. The pressure inside phase separator 102 is measured by first pressure sensor 114. The liquid level inside phase separator 102 is measured by first level transmitter 116. Liquid stream 103 passes through first liquid control valve 105, then into lock hopper 106. The liquid level inside lock hopper 106 is measured by second level transmitter 117. The pressure inside lock hopper 106 is measured by second pressure sensor 115.

Liquid stream 103 passes through first liquid control valve 105, then into lock hopper. Pressurized liquid stream 108 exits lock hopper 106 and passes through second liquid control valve 107. Gaseous stream 109 is fluidically connected to the system between first liquid control valve 105 and lock hopper 106, thereby allowing fluid to enter or exit from this flow path. Gaseous stream 109 is fluidically connected to gaseous vent stream 111 and pressurized gas phase stream 113. The flow of gaseous that is vented as gaseous vent stream 111 is controlled by vent control valve 110. The flow of pressurized gas phase stream 113 that exits gaseous stream 109 is controlled by pressurized gas control valve 112. In subsequent Figures, a control valve that is not filled indicates that that control valve is open, and a control valve that is filled in indicates that that control valve is closed, as indicated in FIG. 1.

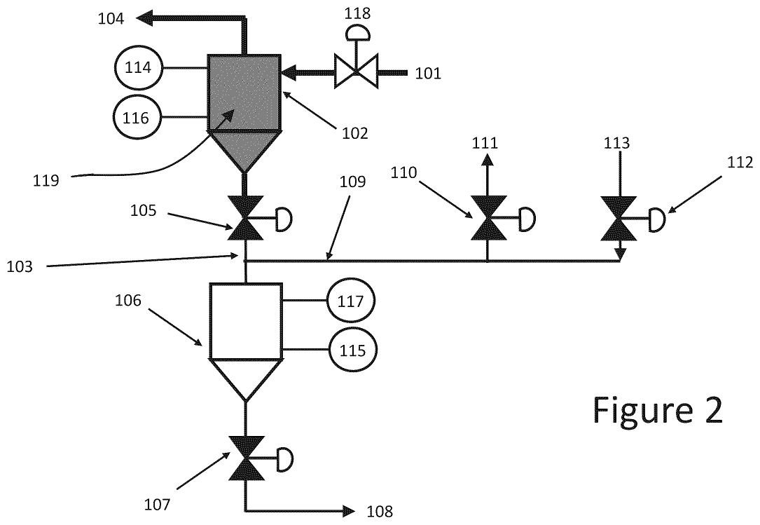

Turning to FIG. 2, the step which may referred to as the “first transition” phase, according to one embodiment of the present invention is provided. Inlet stream control valve 118 is open and two-phase, or liquid phase, stream 101 is introduced into phase separator 102, thereby producing liquid stream 103 and vapor stream 104. Vapor stream 104 exits phase separator 102, and liquid 119 accumulates within phase separator 102. In this step, first liquid control valve 105, second liquid control valve 107, vent control valve 110, and pressurized gas control valve 112 are all closed, and first pressure sensor 114 and second pressure sensor 115 should measure approximately the same pressure. Liquid stream 101 continues to flow into phase separator 102, causing the level to build in phase separator 102 during this step.

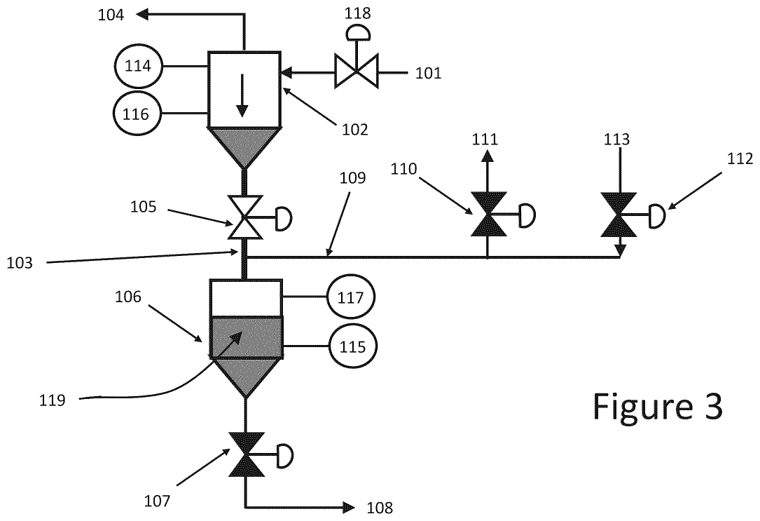

Turning to FIG. 3, the step which may be referred to as “liquid filling” phase, according to one embodiment of the present invention is provided. First liquid control valve 105 is opened, thereby allowing liquid 119 to flow into lock hopper 106 by means of gravity until first level transmitter 116 reaches the control set point. Liquid 119 accumulates within lock hopper 106. At this time, first liquid control valve 105 is closed. In this step, second liquid control valve 107, vent control valve 110, and pressurized gas control valve 112 are all closed, and first pressure sensor 114 and second pressure sensor 115 should measure approximately the same pressure. And lock hopper 106 and phase separator 102 are at approximately the same pressure.

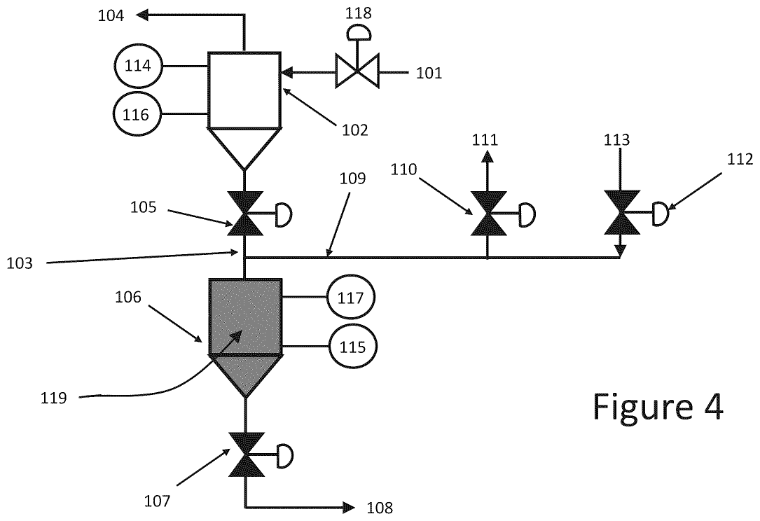

Turning to FIG. 4, the step which may be referred to as the “second transition” phase, according to one embodiment of the present invention is provided. First liquid control valve 105 is closed when second level transmitter 117 reaches its setpoint, thereby preventing any further liquid from flowing into lock hopper 106. At this time, lock hopper 106 will contain the desired amount of liquid 119. In this step, first liquid control valve 105, second liquid control valve 107, vent control valve 110, and pressurized gas control valve 112 are all closed, and lock hopper 106 and phase separator 102 remain at approximately the same pressure. Liquid stream phase separator 101 phase separator 102 continues to flow into phase separator 102, causing the level to build in phase separator 102 during this step. Liquid stream 101 continues to flow into phase separator 102, causing the level to build in phase separator 102 during this step.

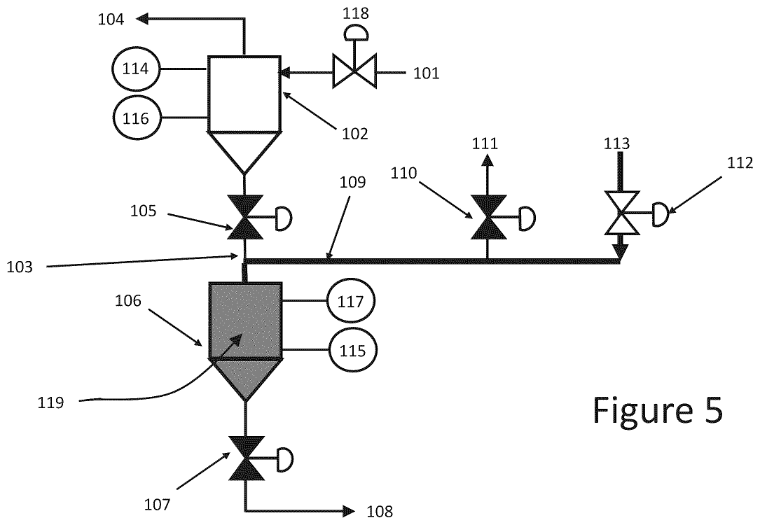

Turning to FIG. 5, the step which may be referred to as “liquid pressurizing” phase, according to one embodiment of the present invention is provided. Pressurized gas control valve 112 is opened, thereby allowing pressurized gas phase stream 113 to flow into lock hopper 106, thereby pressurizing it. In this step, first liquid control valve 105, second liquid control valve 107, and vent control valve 110 are all closed, and second pressure sensor 115 should measure a pressure which is at least adequate to force liquid 119, through the downstream system. Lock hopper 106 and phase separator 102 are at different pressures.

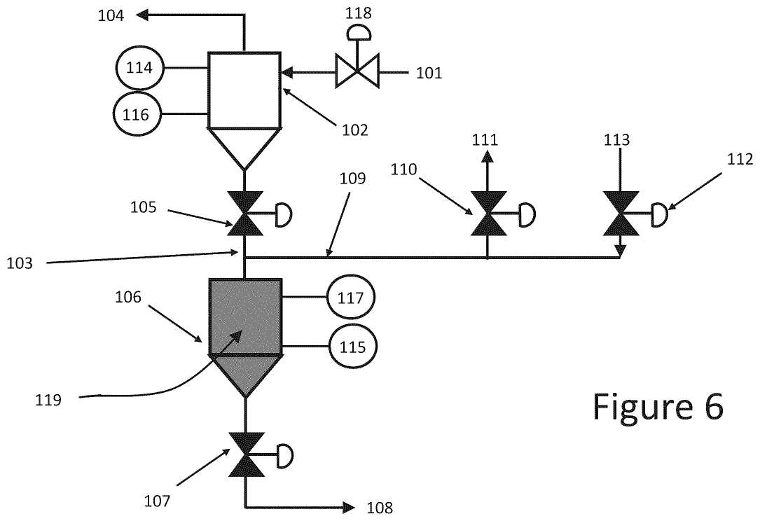

Turning to FIG. 6, the step which may be referred to as the “liquid at pressure” phase, according to one embodiment of the present invention is provided. Pressurized gas control valve 112 is now closed, thereby preventing pressurized gas phase stream 113 from flowing into lock hopper 106 and maintaining lock hopper 106 at the desired pressure. In this step, first liquid control valve 105, second liquid control valve 107, vent control valve 110, and pressurized gas control valve 112 are all closed, and second pressure sensor 115 should measure a pressure which is at least adequate to force liquid 119, through the downstream system. Lock hopper 106 and phase separator 102 are at different pressures. Liquid stream 101 continues to flow into phase separator 102, causing the level to build in phase separator 102 during this step.

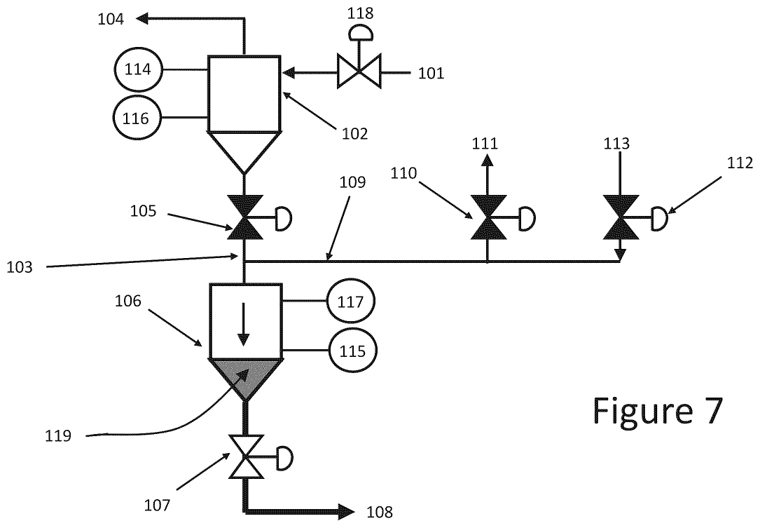

Turning to FIG. 7, the step which may be referred to as “liquid draining” phase, according to one embodiment of the present invention is provided. Second liquid control valve 107 is opened, thereby allowing pressurized liquid 119 to flow out of lock hopper 106, thereby emptying it. In this step, first liquid control valve 105, vent control valve 110 and pressurized gas control valve 112 are all closed, and second pressure sensor 115 should measure a pressure which is dropping to the desired lower pressure. Lock hopper 106 and phase separator 102 are approaching approximately the same pressure. Liquid stream 101 continues to flow into phase separator 102, causing the level to build in phase separator 102 during this step.

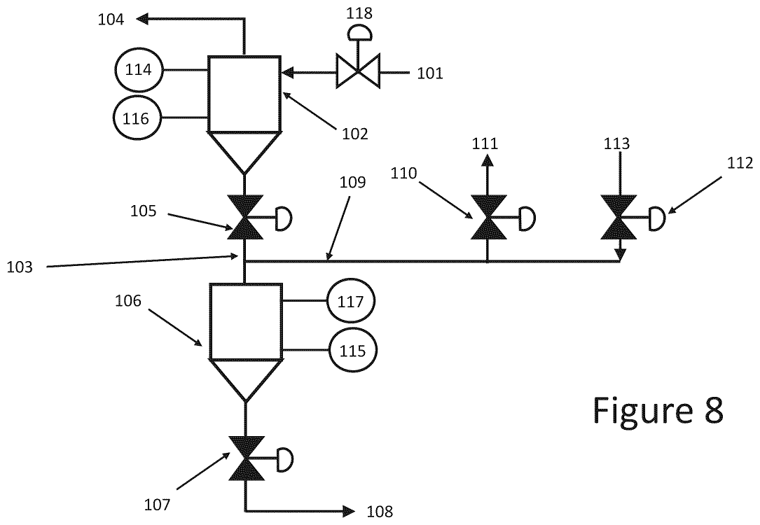

Turning to FIG. 8, the step which may referred to as the “third transition” phase, according to one embodiment of the present invention is provided. This step is the completion of the liquid removal from the system. In the present step, first liquid control valve 105, second liquid control valve 107, vent control valve 110, and pressurized gas control valve 112 are all closed, and first pressure sensor 114 and second pressure sensor 115 should measure approximately the same pressure. No other fluids are flowing in this step. Liquid stream 101 continues to flow into phase separator 102, causing the level to build in phase separator 102 during this step.

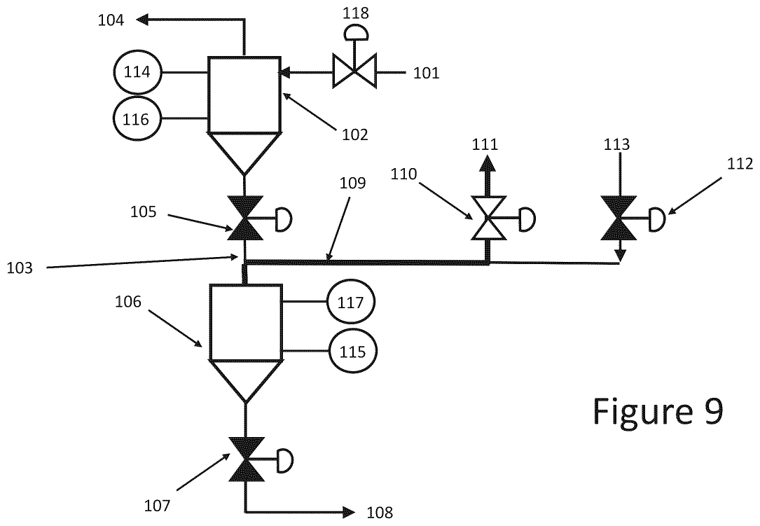

Turning to FIG. 9, the step which may be referred to as “system venting” phase, according to one embodiment of the present invention is provided. Vent control valve 110 is opened, thereby allowing any residual vapors to flow out of lock hopper 106, thereby bringing its pressure to its desired value. In this step, first liquid control valve 105, second liquid control valve 107 and pressurized gas control valve 112 are all closed, and lock hopper 106 and phase separator 102 remain at approximately the same pressure. This step anticipates a repeat of the “first transition step, as described above with FIG. 2. Liquid stream 101 continues to flow into phase separator 102, causing the level to build in phase separator 102 during this step.

The above system will work on any two-phase fluid, or any liquid fluid that is sufficiently reduced in pressure upon entering phase separator 102 to become two-phase. In a preferred embodiment, the fluid is cryogenic. In a more preferred embodiment, the fluid is hydrogen. The non-limiting example described below uses two-phase hydrogen, but the steps and phases described are applicable to any appropriate fluid.

In this non-limiting example, turning to FIG. 2, the step which may referred to as the “first transition” phase, according to one embodiment of the present invention is provided. Inlet stream control valve 118 is open and two-phase, or liquid phase, hydrogen stream 101 is introduced into phase separator 102, thereby producing liquid hydrogen stream 103 and hydrogen vapor stream 104. Hydrogen vapor stream 104 exits phase separator 102, and liquid hydrogen 119 accumulates within phase separator 102. In this step, first liquid control valve 105, second liquid control valve 107, vent control valve 110, and pressurized gas control valve 112 are all closed, and first pressure sensor 114 and second pressure sensor 115 should measure approximately the same pressure. Liquid stream 101 continues to flow into phase separator 102, causing the level to build in phase separator 102 during this step.

Turning to FIG. 3, the step which may be referred to as “liquid filling” phase, according to one embodiment of the present invention is provided. First liquid control valve 105 is opened, thereby allowing liquid hydrogen 119 to flow into lock hopper 106 by means of gravity until first level transmitter 116 reaches the control set point. Liquid hydrogen 119 accumulates within lock hopper 106. At this time, first liquid control valve 105 is closed. In this step, second liquid control valve 107, vent control valve 110, and pressurized gas control valve 112 are all closed, and first pressure sensor 114 and second pressure sensor 115 should measure approximately the same pressure. And lock hopper 106 and phase separator 102 are at approximately the same pressure.

Turning to FIG. 4, the step which may be referred to as the “second transition” phase, according to one embodiment of the present invention is provided. First liquid control valve 105 is closed when second level transmitter 117 reaches its setpoint, thereby preventing any further liquid hydrogen from flowing into lock hopper 106. At this time, lock hopper 106 will contain the desired amount of liquid hydrogen 119. In this step, first liquid control valve 105, second liquid control valve 107, vent control valve 110, and pressurized gas control valve 112 are all closed, and lock hopper 106 and phase separator 102 remain at approximately the same pressure.

Turning to FIG. 5, the step which may be referred to as “liquid pressurizing” phase, according to one embodiment of the present invention is provided. Pressurized gas control valve 112 is opened, thereby allowing pressurized gas phase hydrogen stream 113 to flow into lock hopper 106, thereby pressurizing it. In this step, first liquid control valve 105, second liquid control valve 107, and vent control valve 110 are all closed, and second pressure sensor 115 should measure a pressure which is at least adequate to force liquid 119, through the downstream system. Lock hopper 106 and phase separator 102 are at different pressures.

Turning to FIG. 6, the step which may be referred to as the “liquid at pressure” phase, according to one embodiment of the present invention is provided. Pressurized gas control valve 112 is now closed, thereby preventing pressurized gas phase hydrogen stream 113 from flowing into lock hopper 106 and maintaining lock hopper 106 at the desired pressure. In this step, first liquid control valve 105, second liquid control valve 107, vent control valve 110, and pressurized gas control valve 112 are all closed, and second pressure sensor 115 should measure a pressure which is at least adequate to force liquid 119, through the downstream system. Lock hopper 106 and phase separator 102 are at different pressures. Liquid stream 101 continues to flow into phase separator 102, causing the level to build in phase separator 102 during this step.

Turning to FIG. 7, the step which may be referred to as “liquid draining” phase, according to one embodiment of the present invention is provided. Second liquid control valve 107 is opened, thereby allowing pressurized liquid hydrogen 119 to flow out of lock hopper 106, thereby emptying it. In this step, first liquid control valve 105, vent control valve 110 and pressurized gas control valve 112 are all closed, and second pressure sensor 115 should measure a pressure which is dropping to the desired lower pressure. Lock hopper 106 and phase separator 102 are approaching approximately the same pressure. Liquid stream 101 continues to flow into phase separator 102, causing the level to build in phase separator 102 during this step.

Turning to FIG. 8, the step which may referred to as the “third transition” phase, according to one embodiment of the present invention is provided. This step is the completion of the liquid hydrogen removal from the system. In the present step, first liquid control valve 105, second liquid control valve 107, vent control valve 110, and pressurized gas control valve 112 are all closed, and first pressure sensor 114 and second pressure sensor 115 should measure approximately the same pressure. No other fluids are flowing in this step. Liquid stream 101 continues to flow into phase separator 102, causing the level to build in phase separator 102 during this step.

Turning to FIG. 9, the step which may be referred to as “system venting” phase, according to one embodiment of the present invention is provided. Vent control valve 110 is opened, thereby allowing any residual hydrogen vapors to flow out of lock hopper 106, thereby bringing its pressure to its desired value. In this step, first liquid control valve 105, second liquid control valve 107 and pressurized gas control valve 112 are all closed, and lock hopper 106 and phase separator 102 remain at approximately the same pressure. No other fluids are flowing in this step. This step anticipates a repeat of the “first transition step, as described above with FIG. 2. Liquid stream 101 continues to flow into phase separator 102, causing the level to build in phase separator 102 during this step.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for pressurizing a liquid exiting a phase separator, comprising:
a) providing a two-phase fluid stream to a phase separator, thereby producing a vapor stream and a liquid stream,
b) withdrawing the liquid stream from the phase separator and introducing the liquid stream into a lock hopper,
c) providing a pressurized vapor stream to the lock hopper, thereby pressurizing the lock hopper,
d) withdrawing a pressurized liquid stream from the lock hopper.

2. The method of claim 1, further comprising
e) venting the lock hopper once the lock hopper is empty of pressurized liquid.

3. The method of claim 1, wherein the fluid is a cryogenic fluid.

4. The method of claim 1, wherein the fluid is hydrogen.

5. A method for pressurizing a liquid exiting a phase separator, comprising:
a) opening an inlet control valve,
thereby providing a two-phase fluid stream to a phase separator,
thereby producing a vapor stream and a liquid stream,
wherein a first liquid control valve prevents the liquid stream from leaving the phase separator,
b) opening the first liquid control valve, thereby withdrawing the liquid stream from the phase separator and introducing the liquid stream into a lock hopper,
wherein the lock hopper has a lock hopper pressure,
wherein a second liquid control valve prevents the liquid stream from leaving the lock hopper,
c) closing the first liquid control valve,
d) opening a pressurized vapor control valve,
thereby providing a pressurized vapor stream to the lock hopper,
thereby pressurizing the lock hopper,
e) closing the pressurized vapor control valve,
f) opening the second liquid control valve, thereby withdrawing a pressurized liquid stream from the lock hopper.

6. The method of claim 5, further comprising:
g) closing the second liquid control valve once the lock hopper is empty,
h) opening a vent control valve, thereby venting the contents of the lock hopper.

7. The method of claim 5, wherein in step b) the first liquid control valve is opened by a first level sensor.

8. The method of claim 5, wherein in step c) the first liquid control valve is closed by second level sensor.

9. The method of claim 5, wherein in step e) the pressurized vapor control valve is closed by second pressure sensor.

10. The method of claim 5, wherein the fluid is a cryogenic fluid.

11. The method of claim 5, wherein the fluid is hydrogen.
